(19) United States
(12) Patent Application Publication
(10) Pub. No.: US 2025/0038283 A1
(43) Pub. Date: Jan. 30, 2025

(54) SECONDARY BATTERY AND BATTERY PACK HAVING THE SAME

(71) Applicant: Samsung SDI Co., Ltd., Yongin-si (KR)

(72) Inventor: Kee Yun KIM, Yongin-si (KR)

(21) Appl. No.: 18/509,968

(22) Filed: Nov. 15, 2023

(30) Foreign Application Priority Data
Jul. 28, 2023 (KR) 10-2023-0098854

(51) Int. Cl. H01M 10/48; H01M 10/42; H01M 50/145; H01M 50/184; H01M 50/193; H01M 50/24

(52) U.S. Cl. CPC H01M 10/48; H01M 10/425; H01M 50/145; H01M 50/184; H01M 50/193; H01M 50/24

(57) ABSTRACT

A secondary battery includes: an electrode assembly including a first electrode plate, a separator, and a second electrode plate; a case in which the electrode assembly is accommodated; a cover part closing an open upper side of the case; and a pressure measurement part detachably installed on the cover part and configured to measure a pressure inside the case.

### CROSS-REFERENCE TO RELATED APPLICATION

The present application claims priority to and the benefit of Korean Patent Application No. 10-2023-0098854, filed on Jul. 28, 2023, in the Korean Intellectual Property Office, the entire disclosure of which is incorporated herein by reference.

### BACKGROUND

### 1. Field

Aspects of embodiments of the present disclosure relate to a secondary battery and a battery pack having the same.

### 2. Description of the Related Art

A secondary battery is a power storage device that provides excellent energy density by converting electrical energy into chemical energy and storing the chemical energy. Compared to non-rechargeable (or primary) batteries, secondary batteries are rechargeable and are widely used to power IT devices, such as smartphones, cellular phones, laptops, tablet PCs, and the like. Recently, interest in electric vehicles has increased as a way to reduce or prevent environmental pollution, and thus, high-capacity secondary batteries are being adopted to power electric vehicles. Such secondary batteries should have certain characteristics, such as high density, high output, and stability.

Gas is generated by use of the secondary battery, and gas pressure is generally used as an indicator of an internal state of the secondary battery. The secondary battery may generate gas due in response to various conditions, such as overcharging, overdischarging, and high temperature.

The above-described information acts as the background of the present disclosure is for improving understanding of the present disclosure and, thus, may include information that does not constitute the related (or prior) art.

### SUMMARY

Embodiments of the present disclosure provide a secondary battery capable of measuring an internal pressure of the secondary battery and a battery pack having the same.

Other aspects of some embodiments of the present disclosure provide a pressure measurement part that is detachably installed on a case of the secondary battery.

According to an embodiment of the present disclosure, a secondary battery includes: an electrode assembly including a first electrode plate, a separator, and a second electrode plate; a case in which the electrode assembly is accommodated; a cover part closing an open upper side of the case; and a pressure measurement part detachably installed on the cover part and configured to measure a pressure inside the case.

The pressure measurement part may include: a housing detachably installed on the cover part and comprising by a plurality of members; and a sensor module installed inside the housing and configured to measure a pressure of an inner space defined by the case and the cover part.

The housing may include: a housing body in which the sensor module is mounted therein; a connection protrusion protruding to one side of the housing body and extending to a lower side of the cover part; and a housing cover configured to close an open upper side of the housing body.

An outer surface of the connection protrusion may have a screw thread, and the screw thread may be configured to be coupled to a screw groove defined in the cover part.

The connection protrusion may extend in a vertical direction, and an inner tube may extend in the vertical direction inside the connection protrusion to guide movement of a fluid.

The sensor module may include: a pressure sensor configured to measure a pressure of a fluid moving through the connection protrusion; and a control circuit board connected to the pressure sensor and configured to process a measurement signal of the pressure sensor.

The pressure measurement part may further include a ring-shaped sealing member at a lower side of the housing facing the cover part to block movement of a fluid.

The sealing member may include a material having high corrosion resistance to an electrolyte in the case.

The sealing member may include at least one of modified polyethylene, modified polypropylene, an acrylic resin, a modified acrylic resin, an epoxy resin, and a phenolic resin.

The housing may further include a mounting groove in a bottom surface of the housing facing the sealing member and configured to receive an upper portion of the sealing member therein.

The housing may include a material having high corrosion resistance to an electrolyte in the case.

The housing may include at least one of stainless steel, a plastic, polytetrafluoroethylene, or a ceramic.

According to another embodiment of the present disclosure, a secondary battery includes: an electrode assembly; a case configured to accommodate the electrode assembly together with an electrolyte; a cover part configured to close an open upper side of the case; and a pressure measurement part including a housing detachably installed on the cover part and a sensor module inside the housing. The sensor module is configured to measure a pressure of an inner space defined by the case and the cover part, and the housing includes a material having high corrosion resistance to the electrolyte.

The pressure measurement part may further include a ring-shaped sealing member at a lower side of the housing facing the cover part to block movement of a fluid.

The sealing member may include at least one of modified polyethylene, modified polypropylene, an acrylic resin, a modified acrylic resin, an epoxy resin, and a phenolic resin.

The cover part may include: a cover body fixed to the case and having a mounting hole; and a connector in the mounting hole and from which the pressure measurement part is detachably installed.

The pressure measurement part facing the connector may have a screw thread, and the screw thread may be coupled to a screw groove defined in the connector.

The housing may include: a housing body in which the sensor module is mounted; a connection protrusion protruding to one side of the housing body and extending to a lower side of the cover part; and a housing cover configured to close an open upper side of the housing body. The connection protrusion may extend in a vertical direction, and the connection protrusion may have an inner tube extending in the vertical direction to guide movement of a fluid.

According to another embodiment of the present disclosure, a battery pack includes: a plurality of secondary batteries; an accommodation housing in which the plurality of secondary batteries is accommodated; and an external measurement part installed on the accommodation housing and configured to measure a pressure inside the accommodation housing. Each of the secondary batteries includes: an electrode assembly including a first electrode plate, a separator, and a second electrode plate; a case in which the electrode assembly is arranged; a cover part closing an open upper side of the case; and a pressure measurement part detachably installed on the cover part and configured to measure a pressure inside the case.

The external measurement part may include: a sensor case detachably installed on the accommodation housing to communicate with the inside of the accommodation housing; and a pressure measurement module inside the sensor case and configured to measure a pressure inside the accommodation housing.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, explain aspects and features of the present disclosure.

In the drawings:

FIG. 1 is a perspective view of a secondary battery according to embodiments;

FIG. 2 is a perspective view of the secondary battery shown in FIG. 1 with a pressure measurement part separated from a cover part;

FIG. 3 is an exploded perspective view of the pressure measurement part according to embodiments;

FIG. 4 is a block diagram describing data of the pressure measurement part being transmitted to a controller according to embodiments;

FIG. 5 is a cross-sectional view of the secondary battery shown in FIG. 1 according to embodiments;

FIG. 6 is a cross-sectional view of the secondary battery shown in FIG. 5 with the pressure measurement part separated from the cover part;

FIG. 7 is a cross-sectional view of the cover part with the pressure measurement part coupled thereto;

FIG. 8 is a cross-sectional view of the pressure measurement part separated from the cover part;

FIG. 9 is a cross-sectional view of a connector separated from a cover body according to embodiments; and

FIG. 10 is a block diagram of a battery pack according to embodiments.

### DETAILED DESCRIPTION

Hereinafter, embodiments of the present disclosure will be described, in detail, with reference to the accompanying drawings.

The present disclosure may, however, be embodied in many different forms and should not be construed as being limited to the embodiments set forth herein. Rather, these embodiments are provided so that this disclosure will be thorough and complete and will fully convey the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. Similarly, if a portion is referred to as being “electrically connected” to another portion, it should be understood that the former can be “directly connected” to the latter or “electrically connected” to the latter via an intervening member.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Hereinafter, a secondary battery 1 and a battery pack 200 including the same according to embodiments of the present disclosure will be described with reference to the drawings.

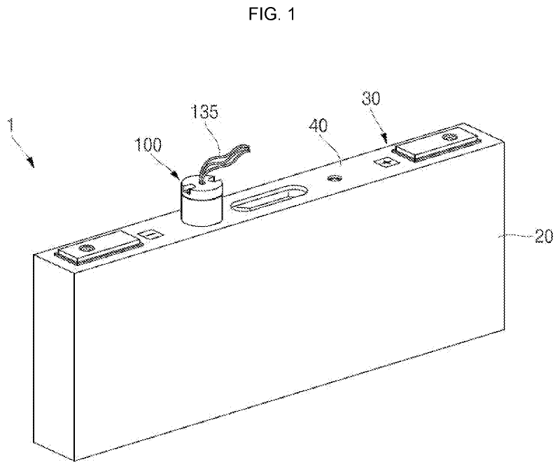

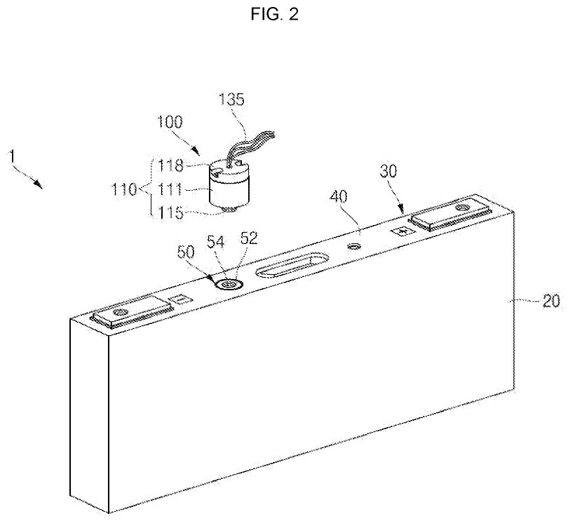

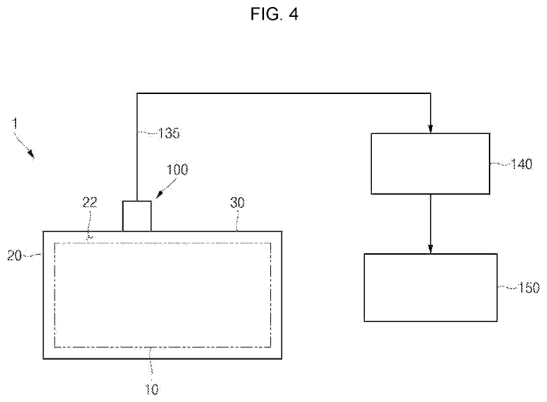

FIG. 1 is a perspective view of the secondary battery 1 according to embodiments, FIG. 2 is a perspective view of a pressure measurement part 100 separated from a cover part 30 of the secondary battery 1 according to embodiments, and FIG. 4 is a block diagram describing data of the pressure measurement part 100 being transmitted to a controller 140 according to embodiments.

As illustrated in FIGS. 1, 2, and 4, in the secondary battery 1 according to embodiments, the pressure measurement part 100 may be installed on a case 20 of the secondary battery 1. Thus, even when the secondary battery 1 is used alone, a pressure inside the case 20 may be measured. In some embodiments, when a plurality of secondary batteries 1 are used together, the pressure measurement part 100 may be installed on each case 20 or may be installed in a housing to measure a pressure in a module unit.

According to embodiments of the present disclosure, the pressure measurement part 100 may be repeatedly used and detachably installed on the case 20 and, thus, may be quickly and easily maintained.

In some embodiments, when the plurality of secondary batteries 1 are provided as a module, the pressure measurement part 100 may be installed on each of the secondary batteries 1 to measure a pressure inside each of the secondary batteries 1. In some embodiments, time and cost required for setting each of the pressure measurement part 100 may be reduced.

The secondary battery 1, according to embodiments, may include an electrode assembly 10, the case 20, the cover part 30, and the pressure measurement part 100.

The electrode assembly 10 may include a first electrode plate, a second electrode plate, and a separator. The first electrode plate may be a positive electrode plate, and the second electrode plate may be a negative electrode plate, but the opposite is also possible. Hereinafter, for convenience of explanation, the first electrode plate will be referred to as a positive electrode plate, and the second electrode plate will be referred to as a negative electrode plate.

The positive electrode plate may include a positive electrode collector made of metal foil, such as aluminum (Al), and may have a positive electrode coating portion where a positive electrode active material, such as transition metal oxide, is coated thereon and a positive electrode non-coating portion that is an area on which the positive electrode active material is not applied.

The negative electrode plate may include a negative electrode collector made of metal foil, such as copper (Cu) or nickel (Ni), and may have a negative electrode coating portion where a negative electrode active material, such as graphite or carbon, is coated thereon and a negative electrode non-coating that is an area on which the negative electrode active material is not applied.

The separator may be made of polyethylene (PE) or polypropylene (PP), but the present disclosure is not limited thereto. The separator may prevent an electrical short from occurring between the positive electrode plate and the negative electrode plate while allowing lithium ions to move therebetween.

The case 20 may be modified in various manners and forms as long as it can accommodate the electrode assembly together with the electrolyte. The case 20 may be made of steel, a steel alloy, aluminum, an aluminum alloy, or an equivalent thereof, but the material thereof is not limited thereto.

An upper side of the case 20 may be open, and the electrode assembly 10 and the electrolyte may be arranged inside of the case 20 through an upper inlet (e.g., the open upper side) of the case 20.

The cover part 30 that shields (e.g., closes and/or seals) the open upper side of the case 20 may be fixed to the case 20, and a sealed space may be defined between the cover part 30 and the case 20. Hereinafter, the cover part 30 will be described in more detail with reference to the drawings.

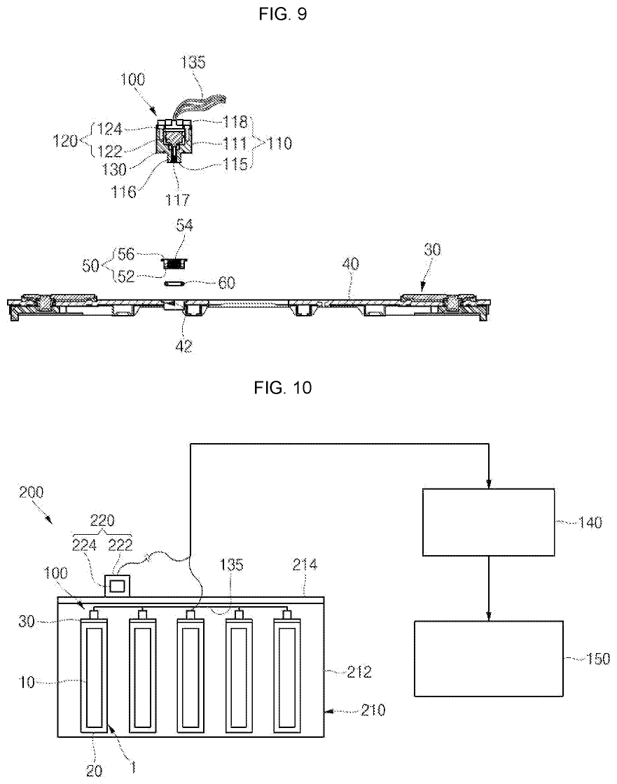

FIG. 8 is a cross-sectional view in which the pressure measurement part 100 is separated from the cover part 30 according to embodiments, and FIG. 9 is a cross-sectional view in which a connector is separated from a cover body according to embodiments.

As illustrated in FIGS. 8 and 9, the cover part 30 may shield the open inlet of the case 20. The cover part 30 may have a substantially plate shape, and the pressure measurement part 100 may be detachably installed on (or in) the cover part 30. The cover part 30 may be provided as a single member but, in other embodiments, a plurality of members may be assembled in the form of a module.

The cover part 30, according to embodiments, may include a cover body 40 and a connector 50. In some embodiments, the cover part 30 may further include an O-ring member 60 installed between the cover body 40 and the connector 50.

The cover body 40 may be a plate-shaped member that covers the open inlet of the case 20 and may have a mounting hole (e.g., a mounting opening) 42 for installing the connector 50. The mounting hole 42 may define a hole (or opening) that passes through the cover body 40 in a vertical direction. The mounting hole 42 may have a shape corresponding to a shape of an outer surface of the connector 50.

The connector 50 may be installed in the mounting hole 42, and various modifications may be possible within the technical idea that the pressure measurement part 100 is detachably installed to the connector 50. The outside of the connector body 52 may be fixed to the cover body 40, and the inside of the connector body 52 may be connected to the pressure measurement part 100. In some embodiments, the pressure measurement part 100 may be fixed to the cover body 40 by using the connector 50 as a medium. The pressure measurement part 100 may have a screw thread 116 facing the connector 50, and also, the screw thread 116 may be coupled to a screw groove 54 provided in the connector 50.

The connector 50, according to embodiments, may include a connector body 52 and a hook protrusion 56. The connector body 52 may extend in the vertical direction and may have a hole extending in the vertical direction at the inside thereof. In some embodiments, the screw groove 54 may be provided on the inside of the connector body 52 to be coupled to the pressure measurement part 100. The outside of the connector body 52 may be fixed to the cover body 40 by screw coupling and may be fixed to the connector body 52 through various fixing methods, such as welding.

The hook protrusion 56 may extend from the upper side of the connector body 52 to the outside of (e.g., away from) the connector body 52 and may be hooked on the cover body 40. When the hook protrusion 56 is hooked on the cover body 40, the hook protrusion 56 and the connector body 52 may be prevented from being separated from each other to a lower side of the cover body 40 (e.g., the connector body 52 may be prevented from falling through the cover body 40). The hook protrusion 56, according to embodiments, may extend in a ring shape and may be hooked with the cover body 40 facing the mounting hole 42.

An O-ring member 60 may be disposed between the connector 50 and the cover body 40 and may be formed into various shapes as long as it blocks a fluid from moving between the connector 50 and the cover body 40. The O-ring member 60, according to embodiments, may have a ring shape and may be elastic.

The O-ring member 60 may be made of rubber including (or containing) silicon or neoprene or plastic including (or containing) PTFE and polyurethane. The O-ring member 60 may have properties, such as oil resistance, heat resistance, and chemical resistance, and may have elastic properties such that it maintains close contact with surrounding (or adjacent) components when subjected to compressive force.

The O-ring member 60 may seal a space between the cover body 40 and the connector 50 to prevent the electrolyte inside the secondary battery 1 from leaking and to prevent external contamination and moisture from being introduced to the inside of the secondary battery 1. In some embodiments, the O-ring member 60 may restrict movement of components due to impact or vibration and improve safety of the secondary battery 1.

The O-ring member 60 may be inserted and mounted in a groove in the connector 50. The O-ring member 60, according to embodiments, may be installed into (e.g., may be inserted into) a concave groove in the outside of the connector body 52.

The detailed configuration of the pressure measurement part 100, according to embodiments, which is detachably installed on the connector 50, will be described below with reference to the drawings.

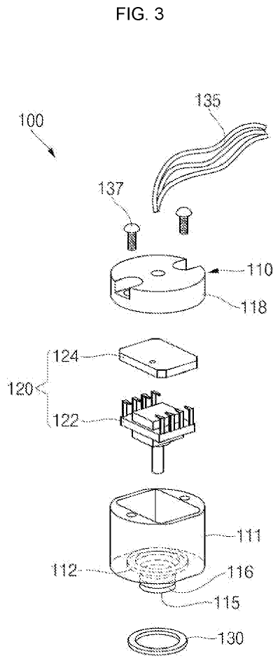

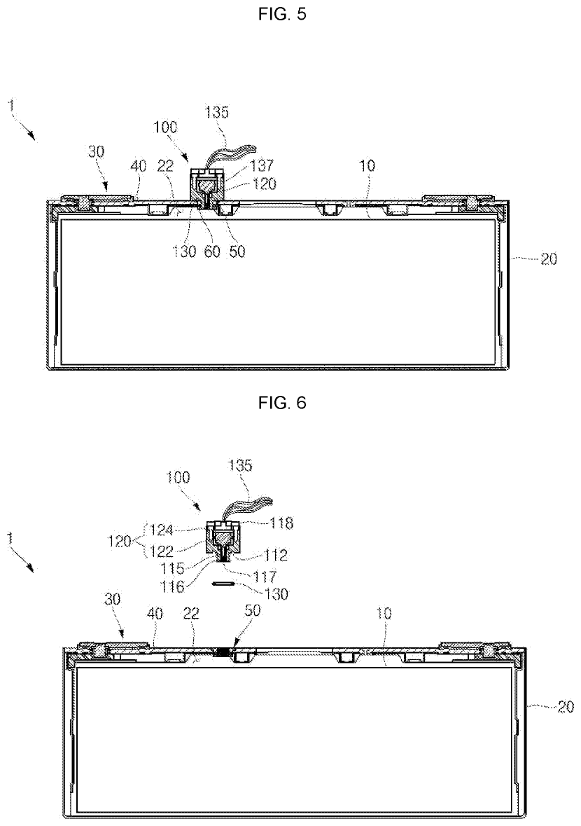

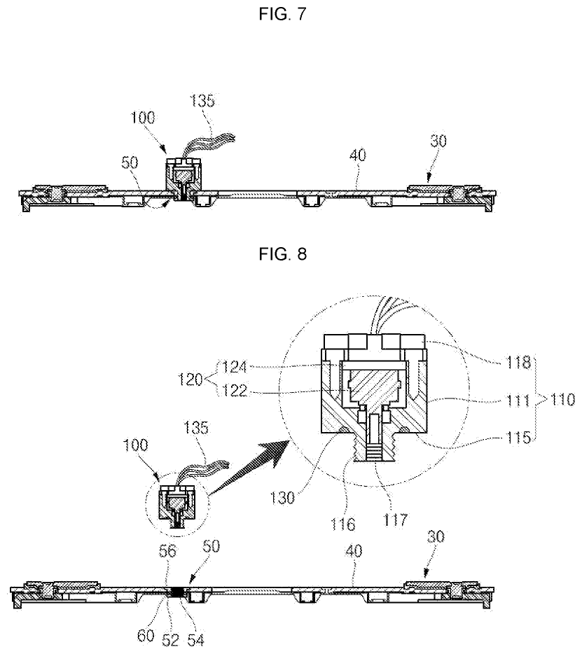

FIG. 3 is an exploded perspective view of the pressure measurement part 100 according to embodiments, FIG. 5 is a cross-sectional view of the secondary battery 1 according to embodiments, FIG. 6 is a cross-sectional view where the pressure measurement part 100 is separated from the cover part 30 according to embodiments, and FIG. 7 is a cross-sectional view in which the pressure measurement part 100 is coupled to the cover part 30 according to embodiments.

As illustrated in FIGS. 3 and 5 to 7, the pressure measurement part 100 may be detachably installed in the cover part 30 and may be formed into various shapes as long as it can measure the pressure inside the case 20. The pressure measurement part 100, according to embodiments, may include a housing 110 and a sensor module 120. In some embodiments, the pressure measurement part 100 may include at least one of a sealing member 130 and a coupling member 137.

The housing 110 may be detachably installed on the cover part 30 and may be formed into various shapes as long as the sensor module 120 can be installed therein. In some embodiments, the housing 110 may be made of a plurality of members. The housing 110 may be made of a material that has high corrosion resistance properties with respect to the electrolyte stored inside the case 20. In some embodiments, the housing 110 may include at least one of stainless steel, plastic, polytetrafluoroethylene (as known as Teflon), or ceramic. The housing 110, according to embodiments, may include a housing body 111, a connection protrusion 115, and a housing cover 118.

The housing body 111 may be modified in various manners within so long as the sensor module 120 can be mounted therein. The housing body 111, according to embodiments, may have an inlet open at an upper side thereof. A space for mounting the sensor module 120 may be provided inside the housing body 111. The connection protrusion 115 may be connected to a lower side of the housing body 111, and the housing cover 118 may be connected to an upper side of the housing body 111.

In some embodiments, the housing 110 may have a mounting groove 112 defined in a bottom surface of the housing 110 (e.g., defined in a bottom surface of the housing body 111) facing the sealing member 130 and into which an upper portion of the sealing member 130 is inserted. The lower side of the housing body 111 may be installed to be in contact with the cover part 30.

The connection protrusion 115 may be modified in various manners within as long as the connection protrusion 115 protrudes from one side of the housing body 111 to extend toward (or to) the lower side of the cover part 30. The connection protrusion 115, according to embodiments, may extend in the vertical direction, and an inner tube (or inner passage) 117 may be provided inside the connection protrusion 115 extending in the vertical direction to guide the movement of the fluid.

The connection protrusion 115 may have a pipe shape extending in the vertical direction. The inner tube 117 may be provided inside the connection protrusion 115, and the screw thread 116 may be disposed outside the connection protrusion 115.

The screw thread 116 of the connection protrusion 115 may be coupled to the screw groove 54 provided in the cover part 30. The connection protrusion 115, according to embodiments, may be inserted into the connector 50, and the screw thread 116 of the connection protrusion 115 may be coupled to the screw groove 54 provided in the connector 50.

The housing cover 118 may be modified in various manners as long as it shields the open upper side of the housing body 111. Because the housing cover 118 is coupled to the upper side of the housing body 111 when the sensor module 120 is mounted inside the housing body 111, measurement accuracy and durability of the sensor module 120 may be improved.

In some embodiments, the housing cover 118 may have an approximately plate shape. When the bolt-shaped coupling member 137 is fixed to the housing body 111 through the housing cover 118, the housing cover 118 may be fixed to the housing body 111. In some embodiments, because the housing cover 118 is separated from the housing body 111 by disassembling the coupling member 137, time and cost required for replacement and inspection of the sensor module 120 may be reduced.

The sensor module 120 may be installed inside the housing 110 and may be variously modified as long as it can measure a pressure in an inner space 22 defined by the case 20 and the cover part 30. The sensor module 120, according to embodiments, may include a pressure sensor 122 and a control circuit board 124.

The inner space 22 may be a space inside the case 20, and the electrode assembly 10 may be installed in the inner space 22. Because the open upper side of the case 20 is shielded (e.g., sealed) by the cover part 30, the inner space 22 is a sealed space defined by the case 20 and the cover part 30. A pressure in the inner space 22 may be increased due to gas generated by the electrode assembly 10.

The pressure sensor 122 may use various types of sensors that are configured to measure a pressure of a fluid moving through the connection protrusion 115. The pressure sensor 122, according to embodiments, may include an inflow tube having a pipe shape disposed in the inner tube 117 of the connection protrusion 115 and a sensor member connected to an upper side of the inflow tube to measure the pressure of the fluid moving through the inflow tube. The fluid in the inner space 22 may move to the sensor member through the inlet tube to measure the pressure of the fluid.

The control circuit board 124 may be variously modified so long as it is connected to the pressure sensor 122 to process a measurement signal of the pressure sensor 122. The control circuit board 124 may act as a control device for the sensor module 120, similar to controller or a central processing unit.

When the control circuit board 124 is coupled to the upper side of the pressure sensor 122, the control circuit board 124 and the pressure sensor 122 may be provided as a module. In some embodiments, the control circuit board 124 and the pressure sensor 122 may be separated from each other so that they may be separately replaced, reducing costs.

The sensor module 120 may measure the gas pressure inside the secondary battery 1. The sensor module 120 may be provided with (or provided in) the pressure measurement part 100 for each secondary battery 1, which is provided in plurality, to sense and monitor abnormal situations, such as an increase in pressure, which may occur in the inner space 22 provided inside the case 20.

The sensor module 120, according to embodiments, may operate by using (e.g., the pressure sensor 122 may be) one of a thermal pressure sensor, a capacitive pressure sensor, a strain gauge pressure sensor, and a fluid pressure sensor.

The thermal pressure sensor 122 may operate based on the principle that a heat change occurs due to a change in gas pressure. If heat transfer of a heat conductor or heat resistor changes due to the increase in pressure, the thermal pressure sensor 122 may sense the change in thermal transfer to measure the pressure change.

The capacitive pressure sensor 122 may measure pressure by sensing a change in capacitance that occurs if the pressure (e.g., increased pressure) is applied. If an interlayer interval of the pressure sensor 122 changes due to the change in pressure, the capacitive pressure sensor 122 may sense the change in interlayer interval as a change in capacitance (or capacity) to measure the pressure.

The strain gauge pressure sensor 122 may operate based on a principle that deformation of a structure occurs if the pressure (e.g., increased pressure) is applied. If a pressure is applied, the strain gauge pressure sensor 122 may generate stress in the internal structure of the pressure sensor 122 to sense the generation of the stress in the deformed form to measure the pressure.

The fluid pressure sensor 122 may convert a pressure into a fluid pressure to measure the pressure. If a pressure is applied, the pressure of the fluid may be changed, and thus, the fluid pressure sensor 122 may sense a pressure changing due to flow of the fluid inside the sensor to measure the pressure.

The sensor module 120 may play a role in monitoring safety and performance of the secondary battery 1. The sensor module 120 may quickly sense the change in gas pressure inside the secondary battery 1 to prevent abnormal situations, thereby contributing to maintaining of the safety of the secondary battery 1. The sensor module 120 may be implemented in various types depending on the design and operation of the secondary battery 1, and the type of sensor module 120 used may vary depending on the type and application of the secondary battery 1.

The sealing member 130 may be installed at a lower side of the housing 110 facing the cover part 30 and may be variously modified as long as it blocks the movement of the fluid. The sealing member 130, according to embodiments, may have a ring shape. In some embodiments, the sealing member 130 may be made of a material that has high corrosion resistance properties with respect to the electrolyte stored inside the case 20.

In some embodiments, the sealing member 130 may include at least one or more of modified polyethylene, modified polypropylene, an acrylic resin, a modified acrylic resin, an epoxy resin, and a phenolic resin.

An upper side of the sealing member 130 may be inserted into the mounting groove 112 in the lower side of the housing 110, and a lower side of the sealing member 130 may be in contact with the connector 50 provided on the cover part 30 to prevent the fluid from moving between the housing 110 and the connector 50.

The sealing member 130 may maintain a seal between the internal components of the secondary battery 1 and the external environment to prevent the electrolyte from leaking. The material of the sealing member 130 used in the secondary battery 1 may include one of silicon, fluorocarbon, and rubber.

Silicon may have excellent heat resistance and durability and may exhibit high corrosion resistance with respect to the electrolyte.

Fluorocarbon may be a material with high chemical stability and durability. Polytetrafluoroethylene (e.g., Teflon®) may be used as a fluorocarbon material and may provide electrical insulation and chemical resistance to achieve safe sealing.

Rubber may have excellent flexibility and elasticity and may provide electrical insulation and sealing properties.

In the state in which the sensor module 120 is installed inside the housing 110, a wire member 135 connected to the sensor module 120 may extend to the outside of the housing 110. The wire member 135 may be connected to the controller 140 installed outside the pressure measurement part 100 to transmit a measured value.

The controller 140 may receive the measured value of the pressure measurement part 100 to generate a control signal for an operation of an indicator 150 (see, e.g., FIG. 4). The controller 140 may analyze the pressure measurement value received from the pressure measurement part 100 to determine whether or not the pressure measurement value is abnormal. The controller 140 may distinguish an abnormal state of pressure by comparing the pressure measurement value to a reference value (e.g., a predefined reference value). For example, if the pressure rises excessively or exceeds a specific range, the controller 140 may sense (or may determine) this state as an abnormal state, inform the abnormal state to a user or worker through the indicator 150, and stop charging and discharging of the secondary battery 1. The controller 140 may primarily operate by using (or based on) a microprocessor or electronic control device.

The indicator 150 may inform the determined result of the controller 140 to the user. The indicator 150 may transmit the abnormal state of the secondary battery 1, the increasing pressure, a warning messages, etc. through visual displays or warning sounds. The indicator 150 may display information by using an LED display, alarm buzzer, text or icon display, etc. As a result, the user or worker may easily determine the state of the secondary battery 1 to take any necessary action.

The types of the controller 140 and the indicator 150 may vary depending on the purpose, size, and application field of the secondary battery 1.

A plurality of the secondary batteries 1 having the above described configuration may be connected together to provide a battery pack 200. The battery pack 200 will be described below with reference to the drawings.

FIG. 10 is a block diagram of a battery pack 200 according to embodiments. As illustrated in FIG. 10, the battery pack 200, according to embodiments, may include a secondary battery 1, an accommodation housing 210, and an external measurement part 220.

The secondary battery 1 may include an electrode assembly having a first electrode plate, a separator, and a second electrode plate, a case 20 in which the electrode assembly and an electrolyte is stored, a cover part 30 that closes an open upper side of the case 20, and a pressure measurement part 100 that is detachably installed in the cover part 30 to measure a pressure inside the case 20. Because the detailed configuration of the secondary battery 1 has been described, repeated detailed description thereof will be omitted.

The plurality of secondary batteries 1 may be accommodated inside the accommodation housing 210, and the pressure measurement part 100 provided in each secondary battery 1 may measure a pressure inside the case 20 in each respective secondary battery 1 and may transmit the measured pressure to the controller 140. In some embodiments, the external measurement part 220 may be installed outside the accommodation housing 210 to measure a pressure inside the accommodation housing 210.

The accommodation housing 210 may be modified in various manners as long as it can accommodate the secondary batteries 1 therein. The accommodation housing 210, according to embodiments, may include a module case 212 that defines a space for accommodating the plurality of secondary batteries 1 therein and has an open upper side and a module cover that closes the open upper side of the module case 212.

The external measurement part 220 may be installed on the module cover 214 to measure the pressure inside the accommodation housing 210. The external measurement part 220 may be installed on at least one of the module case 212 and the module cover 214 of the accommodation housing 210.

The external measurement part 220, according to embodiments, may include a sensor case 222 and a pressure measurement module 224.

The sensor case 222 may be detachably installed on the accommodation housing 210 to communicate with the inside of the accommodation housing 210. The sensor case 222, according to embodiments, may be detachably installed on the module cover 214, and the pressure measurement module 224 may be installed inside the sensor case 222.

The pressure measurement module 224 may be installed inside the sensor case 222 to measure the pressure inside the accommodation housing 210 and may transmit the measured value to the controller 140. The controller 140 may operate the indicator 150 as described above.

The battery pack 200, installed in an electric vehicle, may have a structure in which the plurality of secondary batteries 1 are disposed within the accommodation housing 210. The secondary battery 1 may have a structure that allows charging and discharging through electrochemical reaction between components. When the battery pack 200 generates power, heat may be generated due to the electrochemical reaction, which may increase the temperature inside the accommodation housing 210, and thus, the temperature inside the accommodation housing 210 may rise and deteriorate operation performance of the secondary batteries 1.

Therefore, if the pressure inside the accommodation housing 210 changes due to a rise in temperature inside the accommodation housing 210, the pressure inside the accommodation housing 210 may be measured by the external measurement part 220 installed on the module cover 214 of the accommodation housing 210.

If the pressure inside the accommodation housing 210 exceeds a set value, the controller 140 may transmit a warning message through the indicator 150 to stop the charging/discharging operation.

Because the detailed configuration of the external measurement part 220 is the same or similar to that of the pressure measurement part 100, described above, repeated detailed description thereof will be omitted.

As described above, in the secondary battery 1, according to embodiments, the pressure measurement part 100 may be installed for each case 20, in which the electrode assembly 10 is accommodated, to measure the internal pressure of each case 20, thereby preventing safety accidents from occurring. In some embodiments, because the pressure measurement part 100 is detachably installed on the case 20, reuse and maintenance of the pressure measurement part 100 may be easy, thereby reducing costs. In some embodiments, in the state in which the plurality of secondary batteries 1 are accommodated in the accommodation housing 210, the internal pressures of each of the secondary batteries 1 and the internal pressure of the accommodation housing 210 may be measured to prevent safety accidents from occurring.

In the secondary battery according to the embodiments of the present disclosure, the pressure measurement part may be installed for each case, in which the electrode assembly is accommodated, to measure the internal pressure of each case, thereby preventing safety accidents from occurring.

According to embodiments of the present disclosure, when the pressure measurement part is detachably installed in the case, reuse and maintenance of the pressure measurement part may be easy, thereby reducing cost.

According to embodiments of the present disclosure, in the state in which the plurality of secondary batteries are accommodated in the accommodation housing, each of the internal pressures of the secondary battery and the internal pressure of the accommodation housing may be measured to prevent safety accidents from occurring.

The above-mentioned embodiments are merely embodiments of the secondary battery 1 and the battery pack 200 including the same, and thus, the present disclosure is not limited to the foregoing embodiments. Also, it will be understood by those of ordinary skill in the art that various changes in form and details may be made therein without departing from the spirit and scope of the present disclosure as defined by the following claims and their equivalents.

What is claimed is:

1. A secondary battery comprising:
an electrode assembly comprising a first electrode plate, a separator, and a second electrode plate;
a case in which the electrode assembly is accommodated;
a cover part closing an open upper side of the case; and
a pressure measurement part detachably installed on the cover part and configured to measure a pressure inside the case.

2. The secondary battery as claimed in claim 1, wherein the pressure measurement part comprises:
a housing detachably installed on the cover part and comprising by a plurality of members; and
a sensor module installed inside the housing and configured to measure a pressure of an inner space defined by the case and the cover part.

3. The secondary battery as claimed in claim 2, wherein the housing comprises:
a housing body in which the sensor module is mounted therein;
a connection protrusion protruding to one side of the housing body and extending to a lower side of the cover part; and
a housing cover configured to close an open upper side of the housing body.

4. The secondary battery as claimed in claim 3, wherein an outer surface of the connection protrusion has a screw thread, and
wherein the screw thread is configured to be coupled to a screw groove defined in the cover part.

5. The secondary battery as claimed in claim 3, wherein the connection protrusion extends in a vertical direction, and
wherein an inner tube extends in the vertical direction inside the connection protrusion to guide movement of a fluid.

6. The secondary battery as claimed in claim 3, wherein the sensor module comprises:
a pressure sensor configured to measure a pressure of a fluid moving through the connection protrusion; and
a control circuit board connected to the pressure sensor and configured to process a measurement signal of the pressure sensor.

7. The secondary battery as claimed in claim 2, wherein the pressure measurement part further comprises a ring-shaped sealing member at a lower side of the housing facing the cover part to block movement of a fluid.

8. The secondary battery as claimed in claim 7, wherein the sealing member comprises a material having high corrosion resistance to an electrolyte in the case.

9. The secondary battery as claimed in claim 8, wherein the sealing member comprises at least one of modified polyethylene, modified polypropylene, an acrylic resin, a modified acrylic resin, an epoxy resin, and a phenolic resin.

10. The secondary battery as claimed in claim 7, wherein the housing further comprises a mounting groove in a bottom surface of the housing facing the sealing member and configured to receive an upper portion of the sealing member therein.

11. The secondary battery as claimed in claim 2, wherein the housing comprises a material having high corrosion resistance to an electrolyte in the case.

12. The secondary battery as claimed in claim 11, wherein the housing comprises at least one of stainless steel, a plastic, polytetrafluoroethylene, or a ceramic.

13. A secondary battery comprising:
an electrode assembly;
a case configured to accommodate the electrode assembly together with an electrolyte;
a cover part configured to close an open upper side of the case; and
a pressure measurement part comprising a housing detachably installed on the cover part and a sensor module inside the housing, the sensor module being configured to measure a pressure of an inner space defined by the case and the cover part,
wherein the housing comprises a material having high corrosion resistance to the electrolyte.

14. The secondary battery as claimed in claim 13, wherein the pressure measurement part further comprises a ring-shaped sealing member at a lower side of the housing facing the cover part to block movement of a fluid.

15. The secondary battery as claimed in claim 14, wherein the sealing member comprises at least one of modified polyethylene, modified polypropylene, an acrylic resin, a modified acrylic resin, an epoxy resin, and a phenolic resin.

16. The secondary battery as claimed in claim 14, wherein the cover part comprises:
a cover body fixed to the case and having a mounting hole; and
a connector in the mounting hole and from which the pressure measurement part is detachably installed.

17. The secondary battery as claimed in claim 16, wherein the pressure measurement part facing the connector has a screw thread, and
wherein the screw thread is coupled to a screw groove defined in the connector.

18. The secondary battery as claimed in claim 13, wherein the housing comprises:
a housing body in which the sensor module is mounted;
a connection protrusion protruding to one side of the housing body and extending to a lower side of the cover part; and
a housing cover configured to close an open upper side of the housing body,
wherein the connection protrusion extends in a vertical direction, and
wherein the connection protrusion has an inner tube extending in the vertical direction to guide movement of a fluid.

19. A battery pack comprising:
a plurality of secondary batteries, each of the secondary batteries comprising:
an electrode assembly comprising a first electrode plate, a separator, and a second electrode plate;
a case in which the electrode assembly is arranged;
a cover part closing an open upper side of the case; and
a pressure measurement part detachably installed on the cover part and configured to measure a pressure inside the case;
an accommodation housing in which the plurality of secondary batteries is accommodated; and
an external measurement part installed on the accommodation housing and configured to measure a pressure inside the accommodation housing.

20. The battery pack as claimed in claim 19, wherein the external measurement part comprises:
a sensor case detachably installed on the accommodation housing to communicate with the inside of the accommodation housing; and
a pressure measurement module inside the sensor case and configured to measure a pressure inside the accommodation housing.
